(19) United States
(12) Patent Application Publication
(10) Pub. No.: US 2009/0063267 A1
(43) Pub. Date: Mar. 5, 2009

(54) MOBILE INTELLIGENCE TASKS

(75) Inventors: Micah Dubinko, Sunnyvale, CA (US); Heidi Ann Pollock, San Francisco, CA (US); Olga Volodymyrivna Gavrylyako, Fremont, CA (US); Veeramurthy Veeraprakash, San Jose, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/849,924

(22) Filed: Sep. 4, 2007

(51) Int. Cl. G06Q 30/00

(52) U.S. Cl. 705/14

(57) ABSTRACT

One or more intelligence tasks can be selected by a user on a mobile device. Once the user completes all or portions of an intelligence task, the user's performance of the intelligence task is validated by comparing the user's performance with the performance of the same intelligence task by other users. If the user's performance is validated, the user is provided with an award. In another aspect, the system is directed to collecting information regarding capabilities of various mobile devices through the performance of intelligence tasks. Intelligence tasks that prompt a user to identify or verify capabilities of a mobile device are provided to the user. Based on the validated performance of these intelligence tasks, information regarding the capabilities of various types of mobile devices is obtained. The obtained capability information is utilized to enable rendering of content on one or more mobile devices.

### FIELD OF THE INVENTION

The present invention relates generally to enabling performance of intelligence tasks on mobile devices and, in particular but not exclusively, to collecting information regarding capabilities of various mobile devices through the performance of intelligence tasks.

### BACKGROUND OF THE INVENTION

There are numerous tasks that require human input because the task cannot be performed automatically by a computer or is easier for a human to perform. For some such tasks, the person requesting the performance of the task may not care who actually performs the task as long as the task is performed validly. Furthermore, some such tasks may require utilizing a computing device to complete the task. For these types of tasks as well as others, a person having a mobile computing device may have idle time during the course of his/her day to perform these tasks while, for example, waiting at a doctor's office or at a bank.

One such type of tasks involves identifying and/or verifying the capabilities of various mobile devices. There are thousands of different model types of mobile devices with new model types and new versions of software for existing model types being released regularly. Even when a mobile device itself or the manufacturer of the mobile device provides information about the capabilities of the model type, such information may be incomplete or inaccurate due to software or hardware defects. Accordingly, it may not be possible to ascertain the true capabilities of a mobile device without having a human identify or verify such capabilities.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description Of The Embodiments, which is to be read in association with the accompanying drawings, wherein:

FIG. 1 illustrates a diagram of one embodiment of an exemplary system in which the invention may be practiced;

FIG. 2 illustrates a schematic diagram of one embodiment of an exemplary mobile device;

FIG. 3 illustrates a schematic diagram of one embodiment of an exemplary network device;

FIG. 4A illustrates an exemplary user interface of an exemplary intelligence task application;

FIG. 4B illustrates an exemplary user interface of another exemplary intelligence task application;

FIG. 4C illustrates an exemplary user interface of yet another exemplary intelligence task application;

FIG. 5A illustrates an exemplary flow chart for enabling the performance of an intelligence task on a mobile device;

FIG. 5B illustrates an exemplary flow chart for obtaining capability information of a mobile device through the performance of intelligence tasks; and

FIG. 5C illustrates an exemplary flow chart for identifying or verifying one or more capabilities of a mobile device.

### DETAILED DESCRIPTION OF THE EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

As used herein, the term “mobile client application” refers to an application that runs on a mobile device. A mobile client application may be written in one or more of a variety of languages, such as C, C++, J2ME, Brew, Java, and the like. Browsers, email clients, text messaging clients, calendars, and games are examples of mobile client applications.

Briefly stated, the present invention is directed to enabling the performance of intelligence tasks on mobile devices. An intelligence task is a task, wherein the performance of the task requires the assistance of human input and/or action. The present invention enables a user to select from one or more intelligence tasks from the user's mobile device. An application is provided on the user's mobile device to enable the user to perform one or more user-selected intelligence tasks with the user's mobile device. Once the user completes all or portions of an intelligence task, the user's performance of the intelligence task is validated by comparing the user's performance with the performance of the same intelligence task by other users. In at least one or more embodiments, if the user's performance is validated, the user is provided with an award.

In another aspect, the present invention is directed to collecting information regarding capabilities of various mobile devices through the performance of intelligence tasks. Intelligence tasks which prompt a user to identify or verify capabilities of a mobile device are provided to the user. Based on the validated performance of these intelligence tasks, information regarding the capabilities of various types of mobile devices is obtained. In at least one or more embodiments, the obtained capability information is utilized to enable rendering of content on one or more mobile devices.

In at least one or more embodiments, a mobile client application is provided or downloaded onto a user's mobile device to enable the user to list and/or select from one or more intelligence tasks. Also, in at least one or more embodiments, the application enables the user to view various details concerning an intelligence task such as, for example, a description of the task requester, who is the person or entity requesting the performance of the intelligence task, a description of an award for performing the intelligence task, a description of the estimated amount of time required to complete the intelligence task, and a description of a deadline for completing the intelligence task.

In at least one or more embodiments, an interface is provided to allow a task requester to create or upload an intelligence task. Also, in at least one or more embodiments, an interface is provided to allow a task requester to add and/or remove an intelligence task from the list of intelligence tasks selectable by users of mobile devices. Further, in at least one or more embodiments, an interface is provided to allow a task requester to provide various descriptions.

In at least one or more embodiments, an intelligence task application is provided or downloaded onto a user's mobile device to enable the user to perform a user-selected intelligence task. Also, in at least one or more embodiments, the intelligence task application is also the application for enabling the user to list and/or select from one or more intelligence tasks. Further, in at least one or more embodiments, the intelligence task application receives one or more task files to enable a user to perform an intelligence task. A task file can be, for example, a data file, source code, an executable file, and the like. In at least one or more embodiments, an application for listing and/or selecting one or more intelligence tasks, an intelligence task application, and/or a task file are provided by one or more servers and/or clients to a mobile device over a network.

In at least one or more embodiments, an intelligence task application prompts a user to input one or more responses and/or perform one or more actions. Also, in at least one or more embodiments, at least one datum resulting from a user's performance of all or portions of an intelligence task is received from the intelligence task application. Further, in at least one or more embodiments, a datum can relate to, for example, an answer or other input provided by a user and/or an action performed by the user. Additionally, in at least one or more embodiments, the at least one datum is received by one or more servers and/or clients over a network.

In at least one or more embodiments, the at least one datum provided by a user is compared with at least one other datum provided by other users who have performed the same intelligence task to determine whether the at least one datum provided by the user is valid. Also, in at least one or more embodiments, the at least one datum provided by the user is determined to be valid if it is equivalent to the majority of the at least one other datum provided by other users. Further, in at least one or more embodiments, a comparison to determine whether the at least one datum is valid is performed once a quorum of at least one other datum is available. Additionally, in at least one or more embodiments, an interface is provided to enable a task requester to specify the number of other datum required to constitute a quorum.

In at least one or more embodiments, if the at least one datum provided by a user is determined to be valid, an award is provided to the user. An award can include one or more of, for example, money, credit, voucher, coupon, discount, membership, subscription, service, product, and the like. Also, in at least one or more embodiments, the award is provided by the task requester.

In at least one or more embodiments, an intelligence task application prompts a user to identify or verify a capability of a mobile device. Also, in at least one or more embodiments, the at least one datum provided by the intelligence task application relates to a capability of a mobile device. Further, in at least one or more embodiments, once the at least one datum is determined to be valid, the capability information provided in the at least one datum is associated with a model type of a mobile device. In at least one or more embodiments, the model type of a mobile device is determined by examining one or more headers of one or more messages received from the mobile device. Additionally, in at least one or more embodiments, capability information is provided to one or more servers, clients, and/or applications to enable rendering of content on a mobile device.

In at least one or more embodiments, an intelligence task application for obtaining capability information of a mobile device attempts to display or play at least one content on the mobile device and prompts a user to indicate whether the at least one content was displayed or played. Such an intelligence task application can be used, for example, to obtain information about the types of content supported by the mobile device. Content includes any object that can be displayed including shapes, lines, user interface components, symbols, text, numerals, file formats, and the like. User interface components can include a scroll bar, an input, a button, and the like. A symbol includes a trademark symbol ‘™’, a copyright symbol ‘©’, non-alphanumeric character, and the like. A file format includes various video file formats, audio file formats, text file formats, binary file formats, and the like. Also, in at least one or more embodiments, an intelligence task application prompts the user to indicate the number of content items displayed. For example, the intelligence task application can attempt to display a predetermined number of lines of text or an increasing predetermined number of numerals and prompt the user to indicate the actual number of lines of text displayed or the largest numeral displayed to obtain information about the display capabilities of a mobile device.

In at least one or more embodiments, an intelligence task application for obtaining capability information about a mobile device attempts to display at least two content items and prompts a user to compare the two content items. For example, the intelligence task application can attempt to display text in at least two different fonts and prompt the user to indicate the number of different fonts actually displayed to obtain information about the types of fonts supported by a mobile device. In another example, the intelligence task application can attempt to display a text and a line and prompt the user to indicate whether the text and the line are of the same width to obtain information about sizes of various text displayed on a mobile device.

In at least one or more embodiments, an online platform for enabling the invention can be arranged to operate as a system in one or more local or remote environments, including peer to peer, client-server, stand alone application, web based service, and/or the like. Also, the online platform can be accessed by users, customers, and third parties, with one or more different types of computing devices, including, but not limited to, personal computers, video game consoles, mobile telephones, smart watches, pagers, and/or personal digital assistants (PDA).

### Illustrative Operating Environment

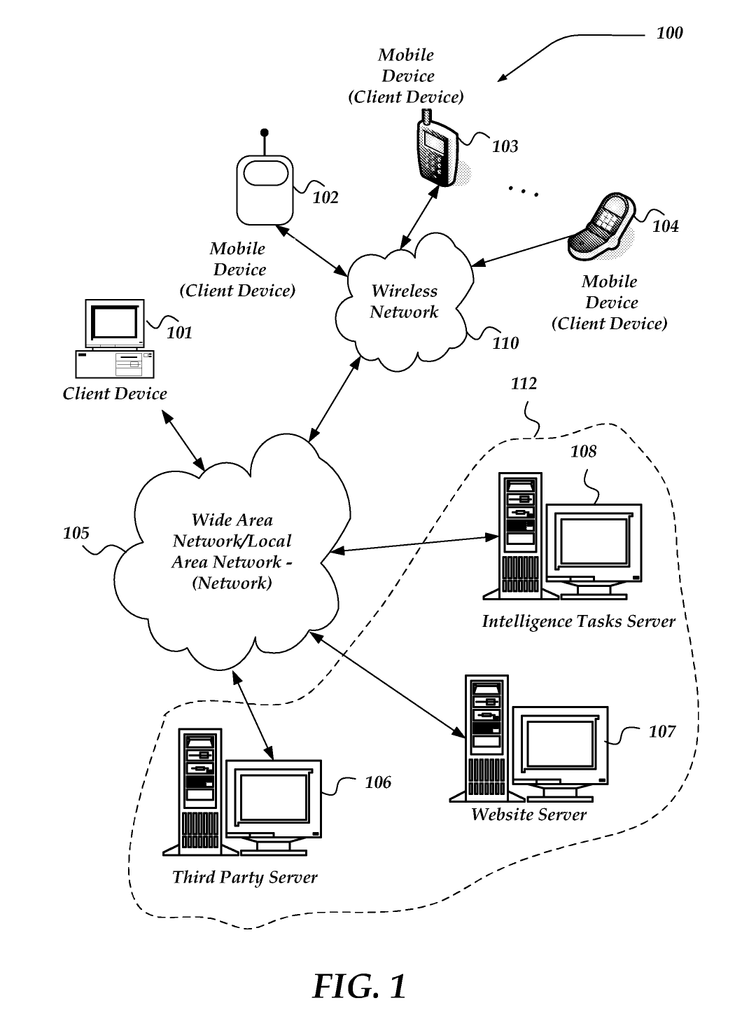

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)-(network) 105, wireless network 110, third party sever 106, website server 107, intelligence tasks server 108, mobile (wireless) devices 102-104, and client device 101.

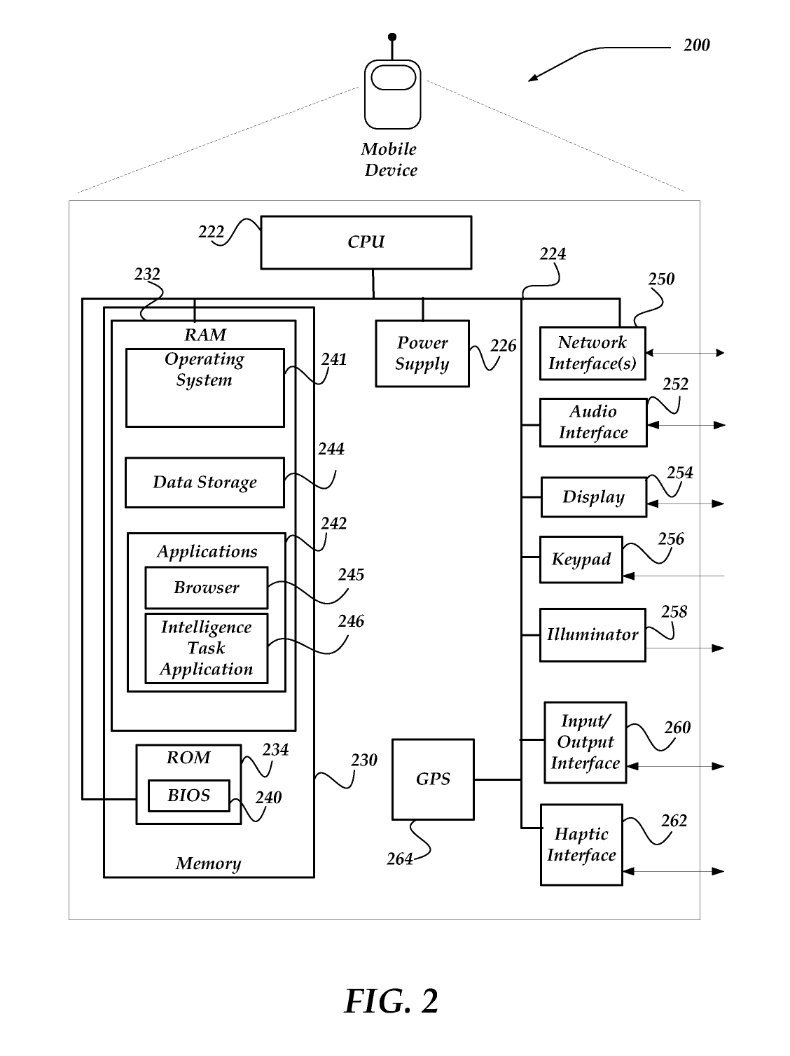

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome display on which only text may be displayed. In another example, a web-enabled mobile device may have a touch sensitive screen, a stylus, and several lines of a color display in which both text and graphics may be displayed.

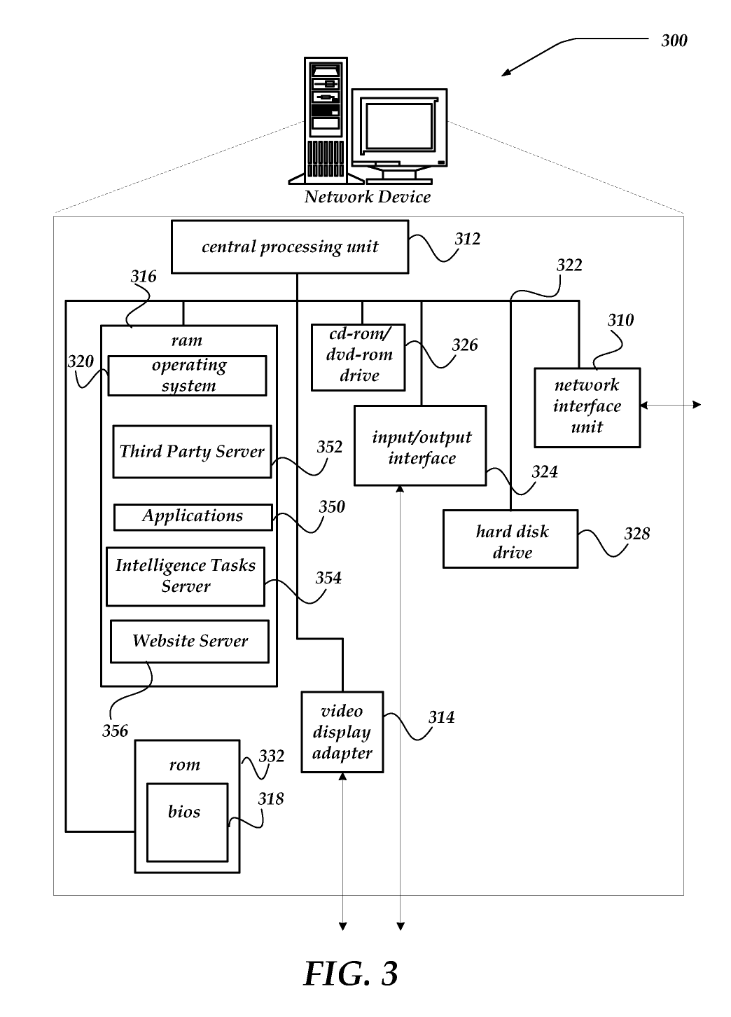

Client device 101 may include virtually any computing device capable of communicating over a network to send and receive information, such as network device 300 shown in FIG. 3, or the like. The set of such client devices may include devices that typically connect using a wired or wireless communications medium such as personal computers, multiprocessor systems, microprocessor-based or programmable consumer electronics, network PCs, or the like.

Mobile devices 102-104 as well as client device 101 may further be configured to include a client application that enables an end-user to log into a membership account on platform 112 that includes servers 106, 107, and 108. Such an end-user membership account, for example, may be configured to enable one or more activities, including: enabling the member to send/receive messages with other members, non-members, and the platform administrator(s); access content on selected web pages; access chat rooms; access blogs; access reviews of products and services by industry experts and/or other members; purchase products and/or services; and try out available demonstrations for products/services prior to purchase. However, participation in at least some of these activities may also be performed without logging into the end-user membership account. Additionally, mobile devices 102-104 may also communicate with non-mobile (wired) client devices, such as client device 101, or the like.

Wireless network 110 is configured to couple mobile devices 102-104 and its components with communication provided over network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further employ a plurality of access technologies including 2nd (2G), 3rd (3G), and 4th (4G) generation radio access for cellular systems, WLAN, WiMax, Wireless Router (WR) mesh, and the like. Access technologies such as 2G, 3G, 3G, and future wireless access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), Universal Mobile Telephone System (UMTS), and the like. In essence, wireless network 110 may include virtually any wireless communication mechanism by which information may travel between mobile devices 102-104 and another computing device, network, and the like.

Network 105 is configured to couple platform 112 and its servers with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between platform 112, client device 101, and other computing devices.

Additionally, communication media typically embodies processor-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Platform 112 can also include a variety of services used to provide services to remotely located members. Such services include, but are not limited to web services, third-party services, audio services, video services, email services, IM services, SMS services, MMS services, VOIP services, video game services, blogs, chat rooms, gaming services, calendaring services, shopping services, photo services, or the like. Although FIG. 1 illustrates platform 112 including servers 106, 107, and 108 as physically separate computing devices, the invention is not so limited. For example, one or all of the servers can be operated on one computing device, without departing from the scope or spirit of the present invention. Also, devices that may operate as platform 112 include personal computers desktop computers, multiprocessor systems, microprocessor-based or programmable consumer electronics, network PCs, servers, and the like.

Intelligence tasks server 108 can provide a mobile device with a list of one or more intelligence tasks and/or one or more applications to enable performance of one or more intelligence tasks on the mobile device, in accordance with the present invention. Furthermore, intelligence tasks server 108 can receive at least one datum resulting from the performance of an intelligence task application, in accordance with the present invention. Additionally, intelligence tasks server 108 can determine if the at least one datum is valid. Also, intelligence tasks server 108 can provide capability information for various types of mobile devices. Such capability information can be utilized, for example, by website server 107 and third party server 106 to enable rendering of content on a mobile device.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), Wide CDMA (CDMA), time division multiple access (TDMA), Universal Mobile Telephone Service (UMTS), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as processor readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, video games, gaming programs, search programs, shopping cart programs, and so forth. Applications 242 may further include browser 245 and intelligence task application 246. The browser application may be configured to receive and display graphics, text, multimedia, and the like, employing virtually any web based language, including a wireless application protocol messages (WAP), and the like. In one embodiment, the browser application for the mobile device is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display content and communicate messages.

Browser 245 may be configured to receive and enable a display of rendered content provided by platform 112. Further, browser 245 enables the user of mobile device 200 to select different actions displayed by the rendered content. In at least one embodiment, browser 245 enables the user to select one or more of a product to purchase, search for content and display the result, call another telephonic device, display and respond to messages, or the like.

### Illustrative Network Device

FIG. 3 shows one embodiment of a network device, according to one embodiment of the invention. Network device 300 may include many more or less components than those shown. The components shown, however, are sufficient to disclose an illustrative embodiment for practicing the invention. Network device 300 may represent, for example, third party server 106, website server 107, intelligence tasks server 108, and/or client device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, cd-rom/dvd-rom drive 326, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC). Network device 300 also comprises input/output interface 324 for communicating with external devices, such as a mouse, keyboard, headset, or other input or output devices not shown in FIG. 3. Input/output interface 324 can utilize one or more communication technologies, such as USB, infrared, Bluetooth™, or the like.

The mass memory as described above illustrates another type of processor-readable storage media. Processor readable storage media may include volatile, nonvolatile, removable, and non-removable media implemented in any method or technology for storage of information, such as processor readable instructions, data structures, program modules, code, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed and read by a processor for a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Intelligence tasks server 354, website server 356, and third party server 352 may also be included as an application program within applications 350. When intelligence tasks server 354, website server 356, or third party server 352 is executing on network device 300, the network device can represent intelligence tasks server 108, website server 107, and third party server 106 respectively. Also, intelligence tasks server 354, website server 356, and third party server 352 can be configured as a platform for enabling the performance of intelligence tasks on mobile devices.

### Illustrative User Interface

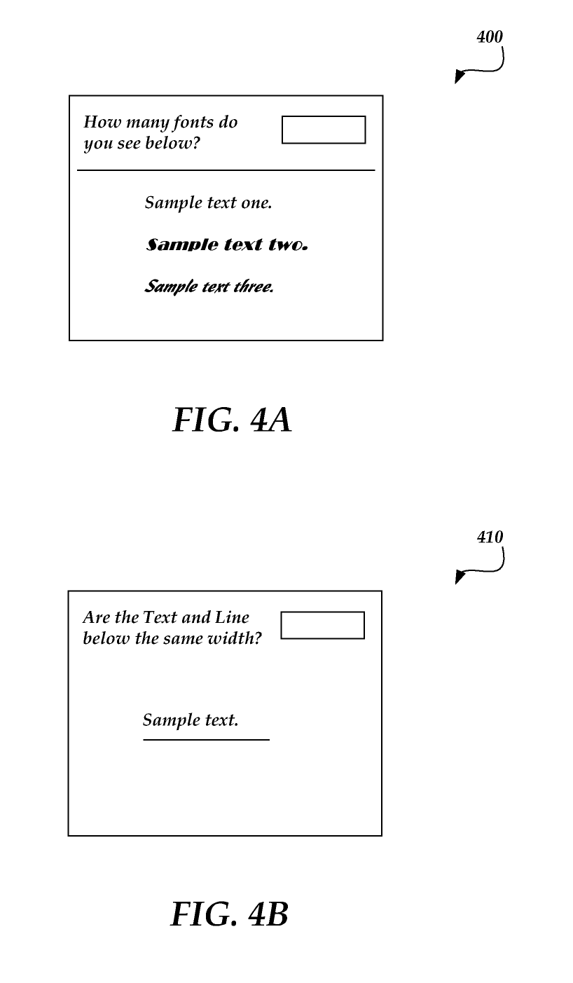

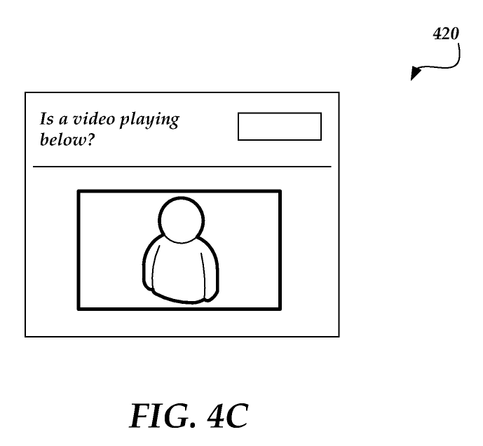

FIG. 4A illustrates exemplary user interface 400 of an exemplary intelligence task application. As shown, in one section of the user interface, a user is prompted with a question asking the user to indicate the number of different fonts displayed in another section of the user interface. In another section of the user interface, several lines of text utilizing different fonts are attempted to be displayed. An input is provided to receive the user's response to the prompt. The exemplary user interface 400 can be utilized, for example, to identify or verify the number of different fonts supported by a mobile device.

FIG. 4B illustrates exemplary user interface 410 of another exemplary intelligence task application. As shown, in one section of the user interface, a user is prompted with a question asking the user to indicate whether the text and line displayed in another section of the user interface have the same width. In another section of the user interface, a text and a line are displayed. An input is provided to receive the user's response to the prompt. The exemplary user interface 410 can be utilized, for example, to identify or verify the amount of space needed to display a particular text.

FIG. 4C illustrates exemplary user interface 420 of yet another exemplary intelligence task application. As shown, in one section of the user interface, a user is prompted with a question asking the user to indicate whether a video is playing in another section of the user interface. In another section of the user interface, a video is attempted to be played. An input is provided to receive the user's response to the prompt. The exemplary user interface 420 can be utilized, for example, to identify or verify the types of video file formats that are supported by a mobile device.

### Illustrative Flow Charts

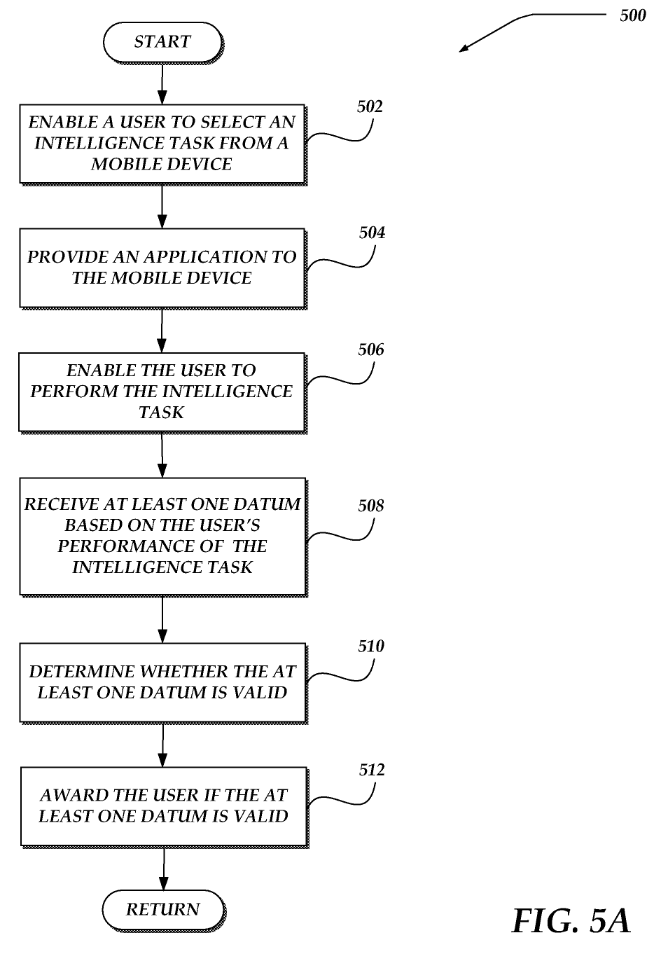

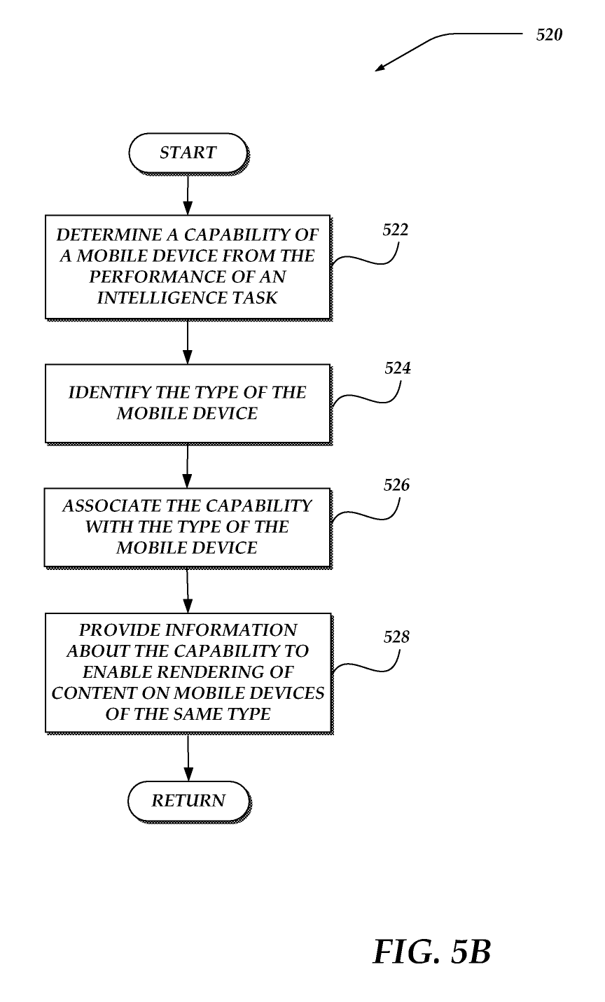

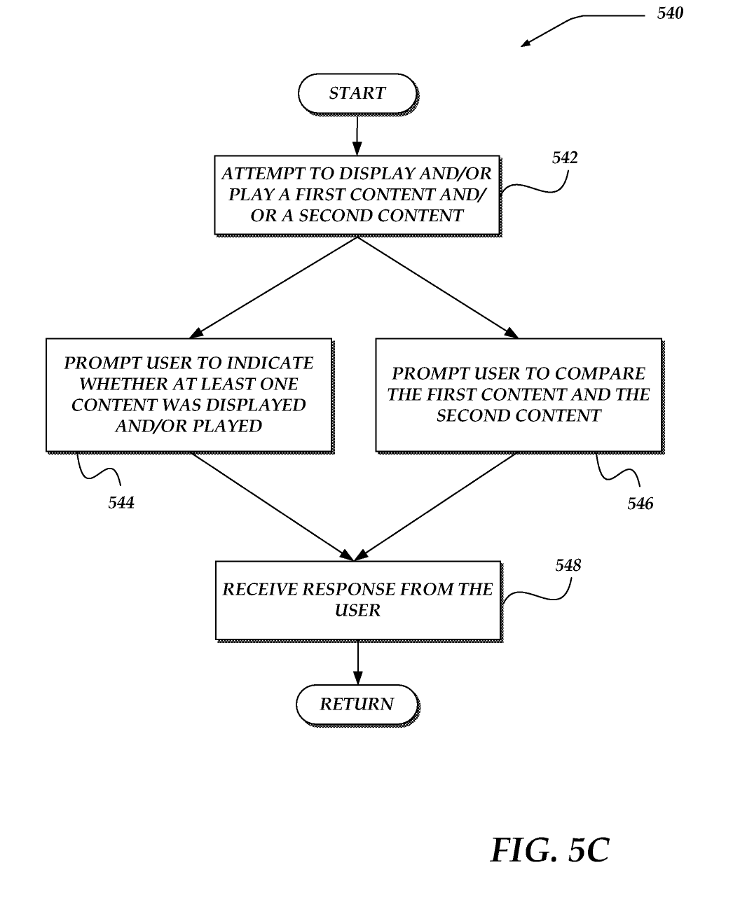

FIG. 5A illustrates a flow chart for an exemplary process 500 for enabling the performance of an intelligence task on a mobile device. Moving from a start block, the process steps to block 502 where a list of one or more intelligence tasks is provided to a mobile device to enable a user to select an intelligence task. In at least one or more embodiments, the list is displayed in a browser. In at least one or more embodiments, an application is provided or downloaded to a mobile device to enable the mobile device to receive and display the list.

Advancing to block 504, an intelligence task application is provided or downloaded to the mobile device to enable a user to perform a user-selected intelligence task. Alternatively, an application available on the mobile device, such as the application for displaying a list of intelligence tasks, can receive additional parameters and/or files to function as an intelligence task application for the user-selected intelligence task.

Flowing to block 506, the intelligence task application is executed to enable a user to perform the user-selected intelligence task.

Next, advancing to block 508, at least one datum is received from the intelligence task application. The at least one datum is related to the user's performance of the intelligence task application. For example, the at least one datum can include an input provided by the user or be a derivative of one or more of the user's input.

Next, flowing to block 510, the process determines whether the at least one datum received is valid. In at least one or more embodiments, the at least one datum is compared with at least one other datum provided by other users who have also performed the same intelligence task. Additionally, in at least one or more embodiments, the at least one datum is determined to be valid if it is equivalent to a majority of the at least one other datum.

Moving to block 512, the process provides an award to the user if the least one datum is determined to be valid. Next, the process returns to performing other actions.

FIG. 5B illustrates a flow chart for an exemplary process 520 for obtaining capability information of a mobile device through the performance of intelligence tasks. Moving from a start block, the process steps to block 522 where intelligence tasks for identifying or verifying one or more capabilities of a mobile device are provided. An exemplary process of an intelligence task for identifying or verifying one or more capabilities of a mobile device is described with reference to FIG. 5C. Utilizing a process such as process 500 of FIG. 5A, at least one valid datum is received which is related to one or more capabilities of a mobile device.

Advancing to block 524, the model type of the mobile device is identified. In at least one or more embodiments, the model type of the mobile device is identified by inspecting one or more headers of one or more messages received from the mobile device.

Flowing to block 526, the capability information obtained in block 522 is associated with the model type identified in block 524.

Moving to block 528, the capability information is provided to one or more of a server, a client, and/or an application to enable rendering of content on one or more mobile devices which are of the model type associated with the capability information. Next, the process returns to performing other actions.

FIG. 5C illustrates a flow chart for an exemplary process 540 for identifying or verifying one or more capabilities of a mobile device. Moving from a start block, the process steps to block 542 where a first content and/or a second content is attempted to be displayed and/or played on a mobile device.

Flowing to block 544, the user is prompted to indicate whether at least one of the first content and/or second content was actually displayed or played. For example, an image of a cat represented by a particular file format can be attempted to be displayed in block 544 and the user can be prompted with a question asking whether the user saw an image of a cat. If the user indicates that the image of a cat was actually displayed and the user's response agrees with the majority of responses from other users, the mobile device is likely to be capable of supporting that particular file format.

Alternatively, advancing to block 546, the user is prompted to compare the first content and the second content. For example, a user can be asked to indicate if a line has the same width as a particular text. If the user indicates that the line and the particular text are the same width and the user's response agrees with the majority of responses from other users, the mobile device is likely to be capable of rendering the particular text within the width of the line.

Advancing to block 548, the user's response is received from the prompt of block 544 or 546. As noted above with respect to blocks 544 and 546, the user's response can be compared with responses from other users to ascertain one or more capabilities of a mobile device. Next, the process returns to performing other actions.

It will be understood that each block of the above flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions executing on the processor provide steps for implementing the actions listed in the flowcharts discussed above.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed as new and desired to be protected by Letters Patent of the United States is:

1. A method for enabling intelligence tasks on a mobile device, comprising:
enabling a user to select an intelligence task from a mobile device;
providing an application to the mobile device for enabling the user to perform the intelligence task;
receiving at least one datum from the application based on the user's performance of the intelligence task;
comparing the at least one datum with at least one other datum received from the performance of the intelligence task by at least one other user to determine whether the user's at least one datum is valid; and
providing the user with an award if the user's datum is valid.

2. The method of claim 1, wherein the at least one datum includes at least one capability information about the mobile device, the method further comprising:
identifying the type of the mobile device; and
associating the at least one capability information with the type of the mobile device.

3. The method of claim 2, further comprising:
providing the at least one capability information to enable rendering of content on a mobile device of the same type.

4. The method of claim 1, wherein the comparing step comprises:
determining whether the user's at least one datum is equivalent to the majority of the at least one other datum received from the performance of the intelligence task by the at least one other user.

5. The method of claim 1, wherein the award comprises at least one of money, credit, voucher, coupon, discount, membership, subscription, service, or product.

6. The method of claim 1, wherein the intelligence task comprises:
attempting to display or play at least one content;
prompting the user to indicate whether the at least one content was displayed or played; and
receiving from the user an indication of whether the content was displayed or played.

7. The method of claim 6, wherein the at least one content includes a scroll bar, an input, a button, or another user interface component.

8. The method of claim 6, wherein the at least one content includes a trademark symbol, a copyright symbol, or a non-alphanumeric character.

9. The method of claim 6, wherein the at least one content includes a video file, an audio file, a text file format, or a binary file format.

10. The method of claim 6, wherein the at least one content includes at least two lines of text, wherein the prompting step comprises:
prompting the user to indicate the number of lines of text displayed on the mobile device.

11. The method of claim 1, wherein the intelligence task comprises:
attempting to display a first content and a second content;
prompting the user to compare the first content and the second content; and
receiving from the user an indication comparing the first content and the second content.

12. The method of claim 11, wherein the first content is a first text with a first font and the second content is a second text with a second font, wherein the prompting step comprises:
prompting the user to compare whether the mobile device displays the first text and the second text with different fonts.

13. The method of claim 11, wherein the first content is a first text and the second content is a line, wherein the prompting step comprises:
prompting the user to compare whether the mobile device displays the first text and the line with the same width.

14. An apparatus for enabling intelligence tasks on a mobile device, comprising:
a memory for storing processor executable data; and
a processor for executing the stored data to enable actions, including:
enabling a user to select an intelligence task from a mobile device;
providing an application to the mobile device for enabling the user to perform the intelligence task;
receiving at least one datum from the application based on the user's performance of the intelligence task;
comparing the at least one datum with at least one other datum received from the performance of the intelligence task by at least one other user to determine whether the user's at least one datum is valid; and
providing the user with an award if the user's datum is valid.

15. The apparatus of claim 14, wherein the at least one datum includes at least one capability information about the mobile device, the actions further comprising:
identifying the type of the mobile device; and
associating the at least one capability information with the type of the mobile device.

16. The apparatus of claim 15, the actions further comprising:
providing the at least one capability information to enable rendering of content on a mobile device of the same type.

17. The apparatus of claim 14, wherein the apparatus is arranged as at least one of a network device, a client device, or a mobile device.

18. A processor-readable medium having processor-executable code stored therein, which when executed by one or more processors, enables actions, comprising:
enabling a user to select an intelligence task from a mobile device;
providing an application to the mobile device for enabling the user to perform the intelligence task;
receiving at least one datum from the application based on the user's performance of the intelligence task;
comparing the at least one datum with at least one other datum received from the performance of the intelligence task by at least one other user to determine whether the user's at least one datum is valid; and
providing the user with an award if the user's datum is valid.

19. The processor-readable medium of claim 18, wherein the at least one datum includes at least one capability information about the mobile device, the actions further comprising:
identifying the type of the mobile device; and
associating the at least one capability information with the type of the mobile device.

20. The processor-readable medium of claim 19, the actions further comprising:
providing the at least one capability information to enable rendering of content on a mobile device of the same type.
